(19) United States
(12) Patent Application Publication
(10) Pub. No.: US 2026/0246878 A1
(43) Pub. Date: Aug. 20, 2026

(54) INFORMATION PROCESSING APPARATUS AND NON-TRANSITORY COMPUTER READABLE MEDIUM

(71) Applicant: FUJIFILM Business Innovation Corp., Tokyo (JP)

(72) Inventor: Katsutoshi SAKAGUCHI, Kanagawa (JP)

(73) Assignee: FUJIFILM Business Innovation Corp., Tokyo (JP)

(21) Appl. No.: 19/309,716

(22) Filed: Aug. 26, 2025

(30) Foreign Application Priority Data
Feb. 17, 2025 (JP) 2025-023464

(51) Int. Cl. H04N 1/00

(52) U.S. Cl. CPC H04N 1/00496; H04N 1/00129; H04N 1/00246; H04N 1/00411; H04N 1/00424; H04N 1/00432; H04N 1/0044; H04N 1/00477; H04N 2201/0094

(57) ABSTRACT

An information processing apparatus includes an operation unit configured to be operated by a user in response to a display and a processor configured to receive the operation performed on the operation unit and control the display output to the operation unit in response to the received operation, in which the processor is configured to output, when a user terminal is communicably connected to the information processing apparatus, the display to the user terminal and receive the operation on the user terminal, and transfer, when a predetermined condition is satisfied, a display output to one of the operation unit and the user terminal and the reception of the operation on the one of the operation unit and the user terminal to the other and continue control.

### CROSS-REFERENCE TO RELATED APPLICATIONS

This application is based on and claims priority under 35 USC 119 from Japanese Patent Application No. 2025-023464 filed February 17, 2025.

### BACKGROUND

### i Technical Field

The present invention relates to an information processing apparatus and a non-transitory computer readable medium.

### ii Related Art

For example, Japanese Unexamined Patent Application Publication No. 2002-331724 discloses a function-extended system in which, in a device including a first operation panel whose functions can be extended by connecting an external device, the external device includes a second operation panel for operating the entire device after the extension. With the system, status display and operation can be performed from the first operation panel separately from status display and operation of the entire device by the second operation panel.

Furthermore, Japanese Unexamined Patent Application Publication No. 2014-197361 discloses a configuration in which an information terminal remotely control an image processing apparatus.

### SUMMARY

Here, a case is considered where a user who is performing an operation using an operation unit of an information processing apparatus or a user terminal connected to the information processing apparatus performs another operation using the other before ending the foregoing operation. In this case, if the user needs to perform the operation performed using one of the devices again using the other, an operational burden on the user increases. By employing a configuration in which an operation performed using one of the devices is transfer to the other, it is possible to reduce the operational burden on the user.

Aspects of non-limiting embodiments of the present disclosure relate to reduction of an operational burden on a user compared to a case where a configuration is not employed in which when the user who is performing an operation using an operation unit of an information processing apparatus or a user terminal connected to the information processing apparatus performs another operation using the other before ending the foregoing operation, the operation performed using the one of the devices is transferred to the other.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus includes an operation unit configured to be operated by a user in response to a display and a processor configured to receive the operation performed on the operation unit and control the display output to the operation unit in response to the received operation, in which the processor is configured to output, when a user terminal is communicably connected to the information processing apparatus, the display to the user terminal and receive the operation on the user terminal, and transfer, when a predetermined condition is satisfied, a display output to one of the operation unit and the user terminal and the reception of the operation on the one of the operation unit and the user terminal to the other and continue control.

### BRIEF DESCRIPTION OF THE DRAWINGS

Exemplary embodiments of the present disclosure will be described in detail based on the following figures, wherein:

FIG. 1 is a diagram illustrating an information processing system;

FIG. 2 is a diagram illustrating an example of hardware configuration of the information processing apparatus;

FIG. 3 is a diagram illustrating an example of hardware configuration of a user terminal;

FIGS. 4A and 4B are functional block diagrams according to an exemplary embodiment: FIG. 4A illustrates the information processing apparatus, and FIG. 4B illustrates the user terminal;

FIG. 5 is a diagram illustrating a screen example of an operation panel of the information processing apparatus and a screen example of augmented reality (AR) glasses;

FIG. 6 is a diagram illustrating a screen example displayed on the operation panel of the information processing apparatus;

FIGS. 7A to 7C are diagrams illustrating various screen examples of the AR glasses: , FIGS. 7A, 7B and 7C illustrate screen examples in order of transition;

FIG. 8 is a sequence diagram illustrating a basic sequence of the information processing system according to the exemplary embodiment;

FIGS. 9A and 9B are sequence diagrams illustrating a first sequence: FIG. 9A illustrates a case where user A desires to switch to the information processing apparatus, and FIG. 9B illustrates a case where user A desires not to switch to the information processing apparatus;

FIG. 10 is a diagram illustrating a screen example indicating an example of a confirmation screen;

FIG. 11 is a sequence diagram illustrating a second sequence;

FIGS. 12A and 12B are diagrams further illustrating the second sequence: FIG. 12A is a diagram illustrating an example of a predetermined positional relationship with the information processing apparatus, and FIG. 12B is a diagram illustrating a screen example of the AR glasses;

FIG. 13 is a diagram illustrating a screen example of the operation panel of the information processing apparatus and a screen example of the AR glasses;

FIG. 14 is a sequence diagram illustrating a third sequence; and

FIG. 15 is a diagram illustrating another example of the predetermined positional relationship with the information processing apparatus.

### DETAILED DESCRIPTION

Exemplary embodiments of the present invention will be described in detail hereinafter with reference to the accompanying drawings.

### System Configuration

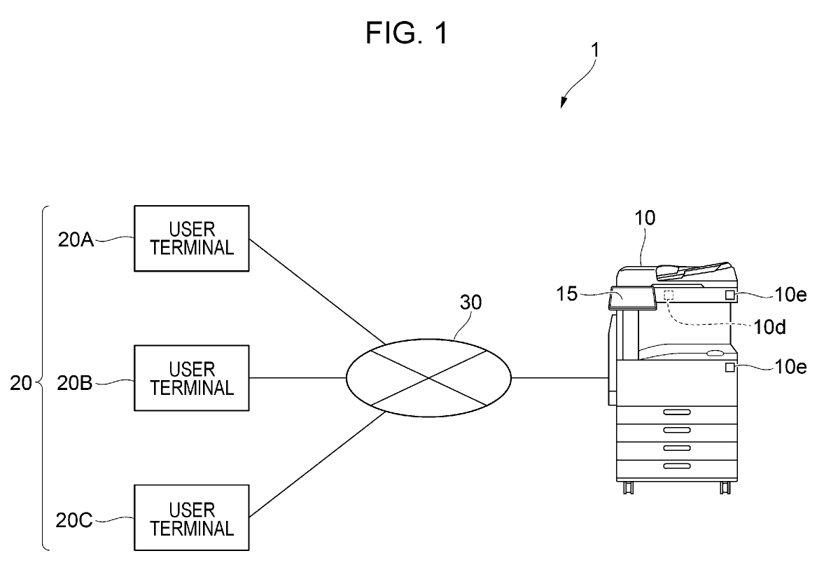

FIG. 1 is a diagram illustrating an information processing system 1. The information processing system 1 includes an information processing apparatus 10 that performs information processing and user terminals 20 operated by users. The user terminals 20 are connectable to the information processing apparatus 10 via a network 30.

Users of the information processing system 1 can cause the information processing apparatus 10 to execute information processing from the user terminals 20. The information processing here refers to causing the information processing apparatus 10 to perform functions thereof, and involves display control on a display unit included in the information processing apparatus 10 or one of display units included in the user terminals 20.

When the information processing apparatus 10 is a printing apparatus, the information processing apparatus 10 has at least a function of printing a document on a sheet of paper. In this sense, the information processing apparatus 10 is also referred to as an image forming apparatus. The information processing apparatus 10 may be dedicated to printing, but may also have other functions. The other functions include, for example, duplication printing (so-called copy printing), reading of documents (scanning), and facsimile. The information processing apparatus 10 may also be referred to as an image forming apparatus.

An installation location of the information processing apparatus 10 is a predetermined location.

The user terminals 20 illustrated in FIG. 1 include, for example, a desktop computer, a laptop computer, a tablet computer, a smartphone, and a mobile terminal. The user terminals 20 may be so-called wearable terminals. The wearable terminals may be of a wristwatch type, a ring type, and a glasses type. Examples of the glasses-type wearable terminal include smart glasses and augmented reality (AR) glasses.

In FIG. 1, user terminals 20 operated by user A, user B, and user C will be referred to as "user terminals 20A, 20B, and 20C", respectively. The term "user terminals 20" will be used as a generic term for the user terminals 20A, 20B, 20C, and the like.

### Hardware Configuration of Information Processing Apparatus

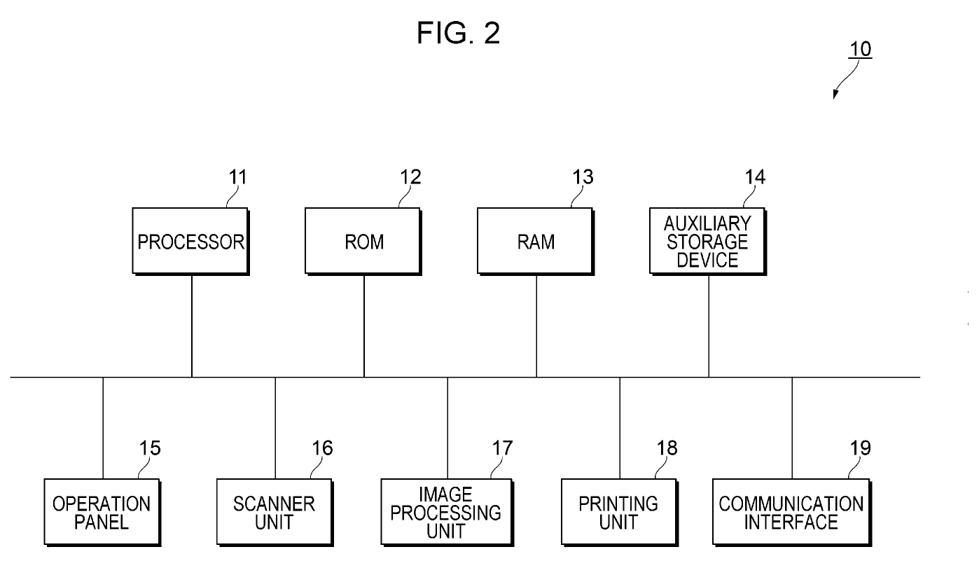

FIG. 2 is a diagram illustrating an example of hardware configuration of the information processing apparatus 10.

The information processing apparatus 10 includes a processor 11, a ROM 12 storing a basic input/output system (BIOS), firmware, and the like, a RAM 13 used as a work area for the processor 11, and an auxiliary storage device 14. The information processing apparatus 10 further includes an operation panel 15 (see FIG. 1), a scanner unit 16, an image processing unit 17, a printing unit 18, and a communication interface 19. The information processing apparatus 10 may include a facsimile machine (not illustrated).

The processor 11 is a device that achieves various functions by executing the firmware. The processor 11, the ROM 12, and the RAM 13 function as a computer.

The auxiliary storage device 14 includes, for example, a hard disk device (HDD) or a semiconductor storage. The auxiliary storage device 14 stores, for example, print jobs and images of documents.

The operation panel 15 is a user interface (UI) that a user operates in response to a display and is, for example, a touch panel (see FIG. 1). The operation panel 15 may sometimes be referred to as a UI.

The scanner unit 16 includes, for example, a light source that radiates illumination light onto a document, an image sensor that captures an image of the document, and a mechanism that conveys the document.

The image processing unit 17 is a processing unit that performs color correction, gradation correction, and other types of image processing on, for example, print jobs or images of documents.

The printing unit 18 is a mechanism that forms an image on a sheet of paper by, for example, an electrophotographic method or an inkjet method.

The communication interface 19 is an interface that achieves communication with the user terminals 20 (see FIG. 1). The communication interface 19 transfers data regarding a document read by the scanner unit 16 to the corresponding user terminal 20. The communication interface 19 also receives print data from the user terminals 20. The communication may be wired or wireless.

The communication interface 19 supports various communication standards. The communication standards here include, for example, Ethernet (registered trademark), Wi-Fi (registered trademark), and mobile communication systems.

### Hardware Configuration of User Terminal

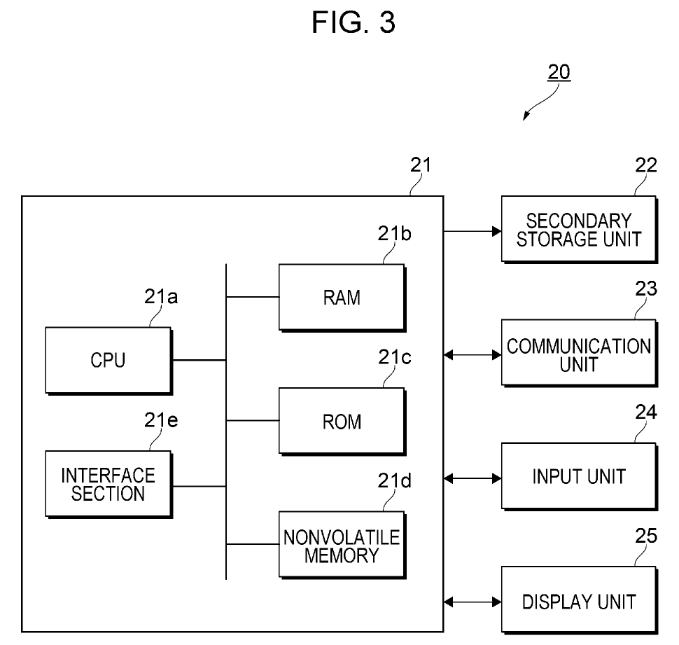

FIG. 3 is a diagram illustrating an example of hardware configuration of each user terminal 20.

The user terminal 20 includes a control unit 21 that controls operation of the entire device, a secondary storage unit 22 that stores various types of information, and a communication unit 23 that transmits and receives information via the network 30 (see FIG. 1). The control unit 21, the secondary storage unit 22, and the communication unit 23 are connected to each other via a bus or a signal line.

The control unit 21 includes, as an example of a processor, a CPU 21a that controls the entire device, a RAM 21b used as a working memory of the CPU 21a, and a ROM 21c that stores programs to be executed by the CPU 21a. The control unit 21 also includes a rewritable nonvolatile memory 21d that can retain data even when power supply is stopped, and an interface section 21e that controls the units connected to the control unit 21 including the communication unit 23.

The nonvolatile memory 21d is, for example, a static random-access memory (SRAM) or a flash memory backed up by a battery. When the control unit 21 reads a program stored in the secondary storage unit 22, each device according to the exemplary embodiment executes corresponding processing.

The secondary storage unit 22 is, for example, an HDD or a semiconductor memory. The secondary storage unit 22 varies depending on a product form of each device. The secondary storage unit 22 stores programs to be executed by the control unit 21 and various types of information.

The user terminal 20 includes an input unit 24, such as a keyboard and a mouse, and a display unit 25, such as a liquid crystal display. When the input unit 24 is a touch panel, the input unit 24 may be provided integrally with the display unit 25.

The information processing apparatus 10 is equipped with a plurality of functions, such as a printing function, and is capable of simultaneously performing multiple jobs using various functions. While one user is using the operation panel 15 of the information processing apparatus 10, however, another user cannot use the operation panel 15 since it is occupied by the foregoing user. That is, the number of users who can simultaneously use operation panels 15 of the information processing apparatus 10 is limited to the number of operation panels 15. For this reason, when the information processing apparatus 10 includes one operation panel 15, for example, only one user can give an instruction to execute a job or the like by operating the operation panel 15.

Therefore, when the information processing apparatus 10 is shared by a plurality of users, a waiting time occurs for users other than the one operating the operation panel 15. As a result, there is a possibility that work efficiency of the other users will decrease.

On the other hand, the information processing apparatus 10 can receive instructions to execute a job or the like from the user terminals 20 connected to the information processing apparatus 10. As a result, a larger number of users than the number of operation panels 15 installed in the information processing apparatus 10 can give instructions to execute a job or the like to the information processing apparatus 10.

The users can give instructions to execute a job to the information processing apparatus 10 through the operation panel 15 or the user terminals 20.

Therefore, the following various situations can be assumed. A first situation is a case where a user is giving an execution instruction or the like to the information processing apparatus 10 using the user terminal 20 because another user is using the operation panel 15 of the information processing apparatus 10. In this case, when the other user has finished using the operation panel 15, the user might desire to switch to the operation panel 15 and perform an operation. In a second situation, a user who is performing an operation using the operation panel 15 desires to switch to the user terminal 20 halfway through the operation and perform the operation.

The switch reduces an operational burden on the user if the operation after the switch does not overlap with the operation before the switch.

In recent years, devices of augmented reality (AR) technologies and mixed reality (MR) technologies have become widespread, and technologies are known in which UI screens are displayed in an AR space different from a real space. When the user terminal 20 is used to give an instruction to execute a job to the information processing apparatus 10, however, an inconvenient situation might occur if the user terminal 20 is the smartphone, the AR glasses, or the like described above. For example, when a user holds a smartphone or an AR glasses operation controller in one hand or both hands, the user's hands are occupied. As a result, a situation where the user cannot set a document in the information processing apparatus 10 or a situation where the user cannot handle a paper tray of the information processing apparatus 10 might occur.

In addition, when the user wears an AR apparatus, his/her field of view is narrowed, which may adversely affect the above-described operability.

Therefore, the first situation described above is assumed.

From the above perspective, the present exemplary embodiment has the following configurations.

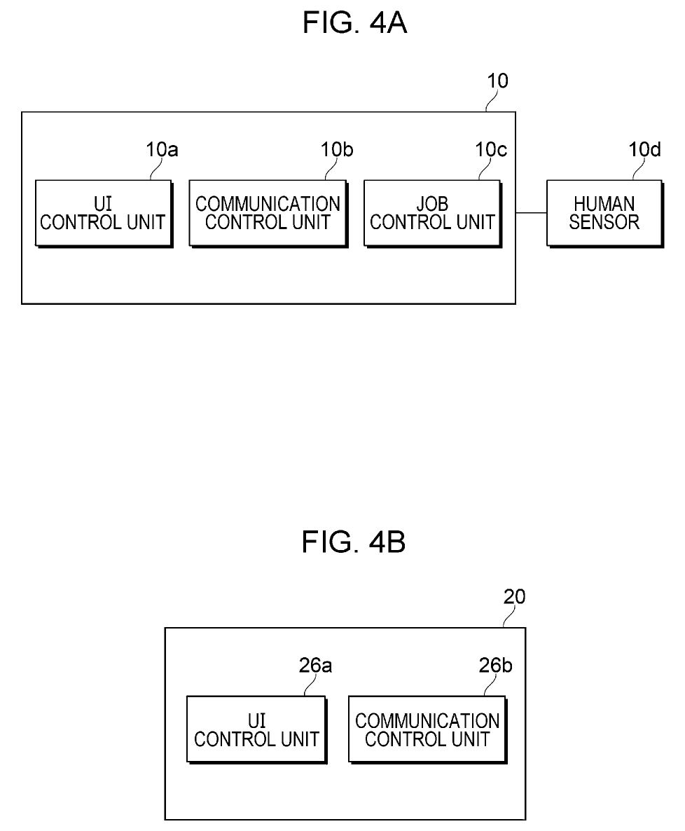

FIGS. 4A and 4B are functional block diagrams according to the present exemplary embodiment: FIG. 4A illustrates the information processing apparatus 10, and FIG. 4B illustrates each user terminal 20.

As illustrated in FIG. 4A, the information processing apparatus 10 includes a UI control unit 10a, a communication control unit 10b, and a job control unit 10c.

The information processing apparatus 10 also includes a human sensor 10d (see FIG. 1). The human sensor 10d is a detection unit that detects presence or absence of a user operating the operation panel 15 or the like in front of the information processing apparatus 10.

The UI control unit 10a of the information processing apparatus 10 generates an operation screen for displaying a status of a job and specifying various job parameters and a job, and displays the operation screen on the operation panel 15. In response to an operation input through the operation panel 15, the UI control unit 10a sets the job parameters and starts the job. Furthermore, the UI control unit 10a manages a state during a user operation with the human sensor 10d, an operation timer (not illustrated), and the like.

The UI control unit 10a also generates an operation screen to be displayed on the user terminal 20. Further, the UI control unit 10a receives an operation on the operation panel 15 and receives an operation on the user terminal 20.

The communication controller 10b controls communication with the user terminal 20.

The job controller 10c receives a job instruction from the UI control unit 10a and controls various devices in accordance with the received job instruction. The job control unit 10c also notifies the UI control unit 10a of a current job status.

As illustrated in FIG. 4B, each of the user terminals 20 includes a UI control unit 26a and a communication control unit 26b.

The UI control unit 26a of the user terminal 20 displays a display instruction received from the information processing apparatus 10 on the user terminal 20. When an input instruction is received from an operation controller attached to the user terminal 20, an instruction to operate a displayed screen is given to the information processing apparatus 10.

The communication control unit 26b controls communication with the information processing apparatus 10.

In the present exemplary embodiment, each processing step is executed by an arbitrary computer. Any computer may execute these processing steps using a processor serving as hardware, a program serving as software, or a combination of these. In this case, the processor is configured to perform the processes in the exemplary embodiments in cooperation with the program and may function as a unit or a means in the exemplary embodiments. The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be achieved by a programmable logic device such as a central processing unit (CPU), a micro-processing unit (MPU), or a field-programmable gate array (FPGA), a dedicated circuit for executing a specific type of processing, such as an application-specific integrated circuit (ASIC), or hardware such as a graphics processing unit (GPU) or a neural processing unit (NPU). Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

Further, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage). The program may be stored in such a divided manner in multiple non-transitory computer readable media present in apparatuses physically away from each other. The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content.

### First Exemplary Embodiment

Next, a first exemplary embodiment will be described.

First, a relationship between the operation panel 15 of the information processing apparatus 10 and the AR glasses 51 according to the first exemplary embodiment will be described. The AR glasses 51 are not a part of the information processing apparatus 10.

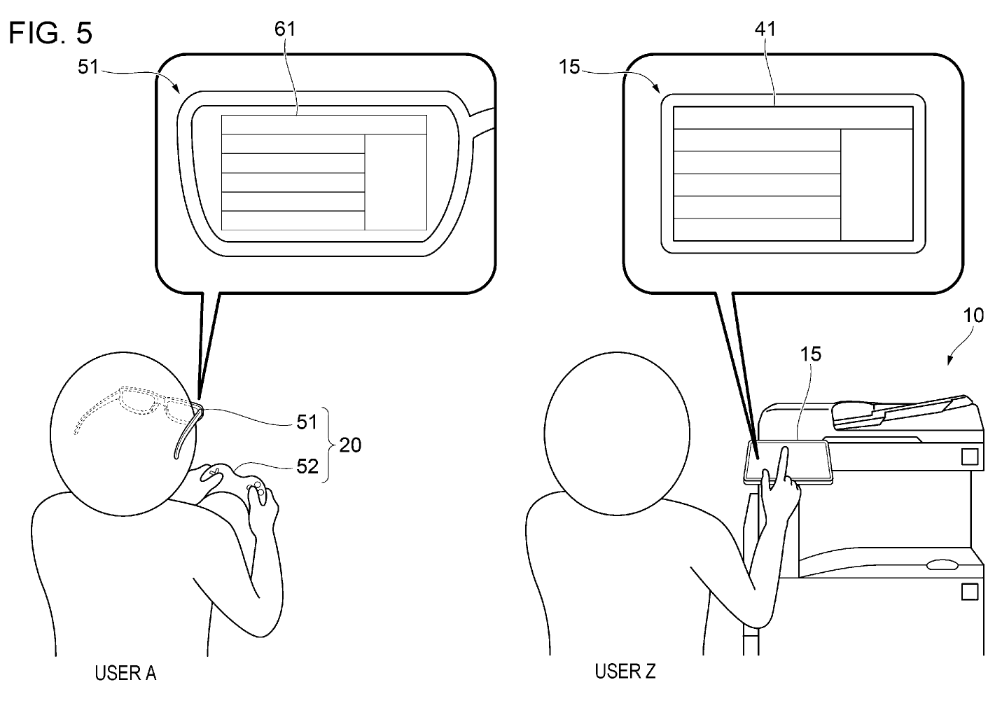

FIG. 5 is a diagram illustrating a screen example 41 on the operation panel 15 of the information processing apparatus 10 and a screen example 61 on the AR glasses 51. The AR glasses 51 and the controller 52 illustrated in FIG. 5 constitute the user terminal 20. The AR glasses 51 correspond to a display unit, and the controller 52 corresponds to an input unit.

As illustrated in FIG. 5, the operation panel 15 is operated by user Z, and the AR glasses 51 are used by user A. The operation panel 15 is an example of an operation unit, and the AR glasses 51 and the controller 52 are an example of a user terminal.

As illustrated in FIG. 5, a screen example 41 is displayed on the operation panel 15 of the information processing apparatus 10. The AR glasses 51 also display a screen example 61. The screen examples 41 and 61 are an example of screens showing the same content.

More specifically, the screen example 41 of the operation panel 15 and the screen example 61 of the AR glasses 51 have the same design and the same screen specifications. The screen example 41 of the operation panel 15 and the screen example 61 of the AR glasses 51 have a common display mode. For example, general layout and character size are the same. There is no layout break or font difference between the two.

As a result, a sense of discomfort is reduced when switching from one of the operation panel 15 and the AR glasses 51 to the other.

Whereas the screen example 61 of the AR glasses 51 is different in size from the operation panel 15 in the example illustrated in FIG. 5, the screen example 61 appears to be the same size as the operation panel 15 when user A wears the AR glasses 51.

The screen example 41 of the operation panel 15 illustrated in FIG. 5 is generated by the UI control unit 10a (see FIG. 4A) of the information processing apparatus 10.

The screen example 61 of the AR glasses 51 is generated by the UI control unit 10a of the information processing apparatus 10 (see FIG. 4A) and displayed by the UI control unit 26a (see FIG. 4B).

The screen example 41 of the operation panel 15 and the screen example 61 of the AR glasses 51 are thus generated by the UI control unit 10a of the information processing apparatus 10.

The AR glasses 51 as the user terminal 20 illustrated in FIG. 5 are communicably connected to the information processing apparatus 10. As many user terminals 20 as the number of users who desire to connect can be connected to the information processing apparatus 10.

More specifically, user A wears the AR glasses 51 as the user terminal 20 and connects to the information processing apparatus 10. The connection is established using, for example, AR markers 10e (see FIG. 1) provided on an outer surface of the information processing apparatus 10.

The AR markers 10e are recognized by the user terminal 20. Although the AR markers 10e are arranged vertically, the arrangement of the AR markers 10e is not limited thereto, and the AR markers 10e may be arranged horizontally. Although two AR markers 10e are provided in the present exemplary embodiment, the number of AR markers SL may be different, instead.

When the user terminal 20 has read one of the two AR markers 10e arranged horizontally, for example, the information processing apparatus 10 can recognize a position of user A relative to the information processing apparatus 10. A result of the recognition may be reflected in the display on the AR glasses 51.

When the user terminal 20 has read the AR markers 10e, communication with the information processing apparatus 10 starts. As the communication, for example, Bluetooth Low Energy (BLE) communication may be employed. The BLE communication is a type of Bluetooth (registered trademark) and is a power-saving wireless communication scheme.

With the BLE communication, communication connection is possible within a range of up to about 50 meters, and position detection is possible. Based on strength of radio waves in the BLE communication, the information processing apparatus 10 can estimate a distance to the connected user terminal 20.

The example screen 61 of the AR glasses 51 displays a real space with an added virtual AR space. More specifically, the screen example 61 has the same display content as that when the operation panel 15 of the information processing apparatus 10 is operated.

In the present exemplary embodiment, by displaying the screen example 61 of the AR glasses 51 in the AR space, the screen example 41 of the operation panel 15 and the screen example 61 have the same design as described above, thereby ensuring consistency.

In addition to the case where the screen example 61 is displayed in the AR space, another technique may be used. For example, although it is difficult to ensure the consistency of the screens, the screen example 61 may be displayed using a general browser technology.

Screen Example of Operation Panel 15 and Screen Example of AR Glasses 51

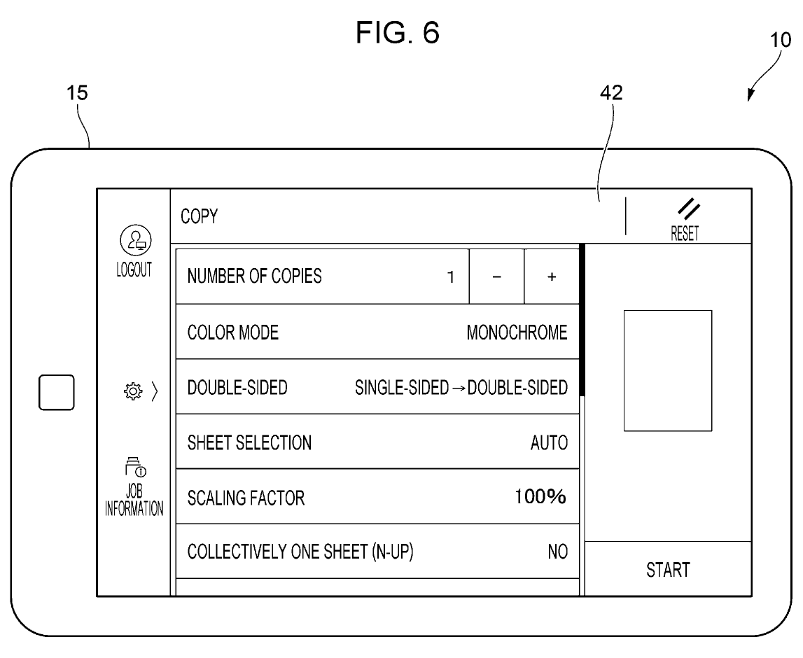

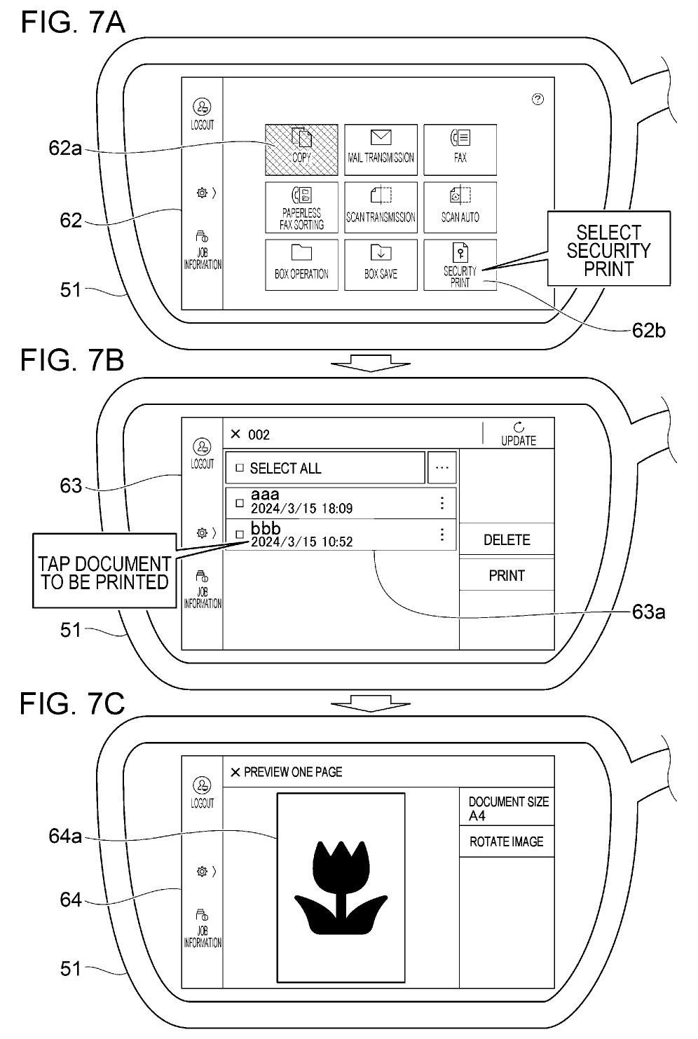

FIG. 6 is a diagram illustrating a screen example 42 displayed on the operation panel 15 of the information processing apparatus 10, and FIGS. 7A to 7C are diagrams illustrating various screen examples of the AR glasses 51. ,FIGS. 7A, 7B and 7C illustrate screen examples 62, 63, and 64 displayed as a result of sequential transition. It is assumed that the operation panel 15 is operated by user Z (see FIG. 5) and the AR glasses 51 are used by user A (see FIG. 5).

The screen example 42 illustrated in FIG. 6 is displayed when a copy job is being executed. The screen example 62 illustrated in FIG. 7A is an example of an initial screen displayed first. The screen example 62 is displayed in the AR space.

More specifically, as illustrated in FIG. 6, the screen example 42 illustrates a state where a copy job is being executed in response to an instruction from the operation panel 15. In the screen example 62 of the AR glasses 51 illustrated in FIG. 7A, therefore, exclusive control is performed to prevent the user from pressing a copy button 62a. In FIG. 7A, the copy button 62a is shaded to visually indicate the exclusive control.

With regard to the AR glasses 51 illustrated in FIG. 7A, nine job specification buttons including the copy button 62a in the screen example 62 are originally executable by the information processing apparatus 10. The shaded copy button 62a in FIG. 7A, however, corresponds to an item that is being executed as a result of an operation performed on the information processing apparatus 10. The copy button 62a illustrated in FIG. 7A is an example of a display indicating that an operation is disabled in the AR glasses 51.

More specifically, as illustrated in FIG. 7A, in addition to a case where each job specification button is disabled, a related item may also be disabled. In the former case, for example, when a copy job is being executed, another copy job is disabled but a scan transmission job is not disabled. In the latter case, for example, when a copy job is being executed, another copy job and a scan transmission job are disabled.

In the screen example 62 of the AR glasses 51 illustrated in FIG. 7A, it is assumed that a button other than the copy button 62a, for example, a security print button 62b, is selected. As a result, the screen transitions to the screen example 63.

In the screen example 63 illustrated in FIG. 7B, a login name "002" of user A is displayed, and a plurality of print documents is displayed in a list below the login name. When the user taps an area 63a among the plurality of print documents to select a document "bbb", the screen transitions to the screen example 64 illustrated in FIG. 7C.

In the screen example 64 illustrated in FIG. 7C, a preview image 64a of the document "bbb" is displayed.

The AR glasses 51 can thus execute jobs and processes other than the copy job executed using the operation panel 15.

### Example of Basic Sequence

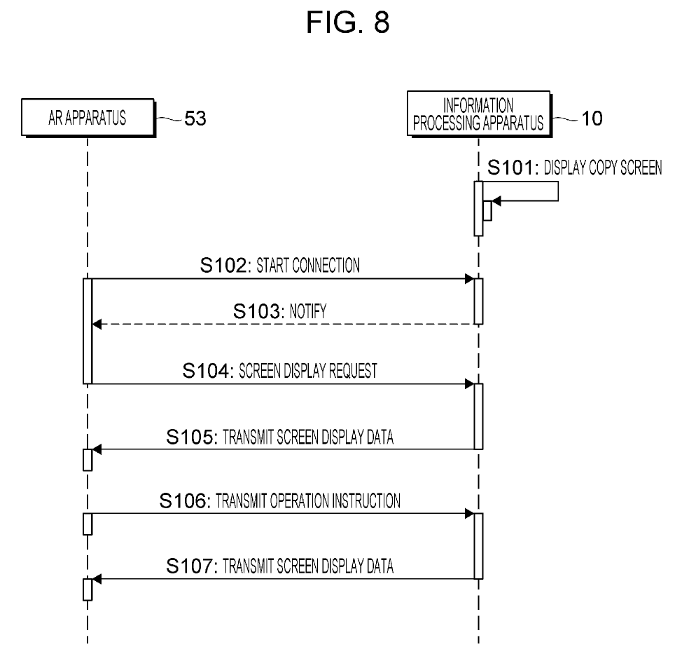

FIG. 8 is a sequence diagram illustrating a basic sequence of the information processing system according to the present exemplary embodiment. The AR glasses 51 and the controller 52 (see FIG. 5) as the user terminal 20 will be referred to as an "AR apparatus 53" hereinafter.

In the example illustrated in FIG. 8, it is assumed that user Z (see FIG. 5) operates the operation panel 15 (see FIG. 5) to cause the information processing apparatus 10 to execute a copy job. As a result, the information processing apparatus 10 displays a copy screen, which is a screen for copying, on the operation panel 15 (see FIG. 5) (step 101). The copy job is executed by the job control unit 10c (see FIG. 4A).

When user A (see FIG. 5) operates the AR apparatus 53 to start connection to the information processing apparatus 10 (step 102), the information processing apparatus 10 issues a connection confirmation notification (step 103). The notification may be transmission of a predetermined signal.

Next, when the AR apparatus 53 issues a screen display request to the information processing apparatus 10 (step 104), the information processing apparatus 10 transmits screen display data (step 105). The screen display data is data regarding an initial screen, and is generated by the UI control unit 10a (see FIG. 4A) of the information processing apparatus 10.

As a result, the initial screen is displayed on the AR glasses 51 (see FIG. 5) of the AR apparatus 53.

When the controller 52 (see FIG. 5) of the AR apparatus 53 is then operated by user A (see FIG. 5), the AR apparatus 53 identifies the operation using the UI control unit 26a (see FIG. 4B). The identified operation is an instruction to execute a job other than the copy job, and is, for example, mail transmission.

In the AR apparatus 53, an operation instruction corresponding to the identified operation is transmitted to the information processing apparatus 10 using the communication controller 26b (see FIG. 4B) (step 106).

The information processing apparatus 10 transmits screen display data corresponding to the received operation instruction (step 107). The screen display data transmitted in step 107 is generated by the UI control unit 10a (see FIG. 4A) of the information processing apparatus 10.

### Example of First Sequence

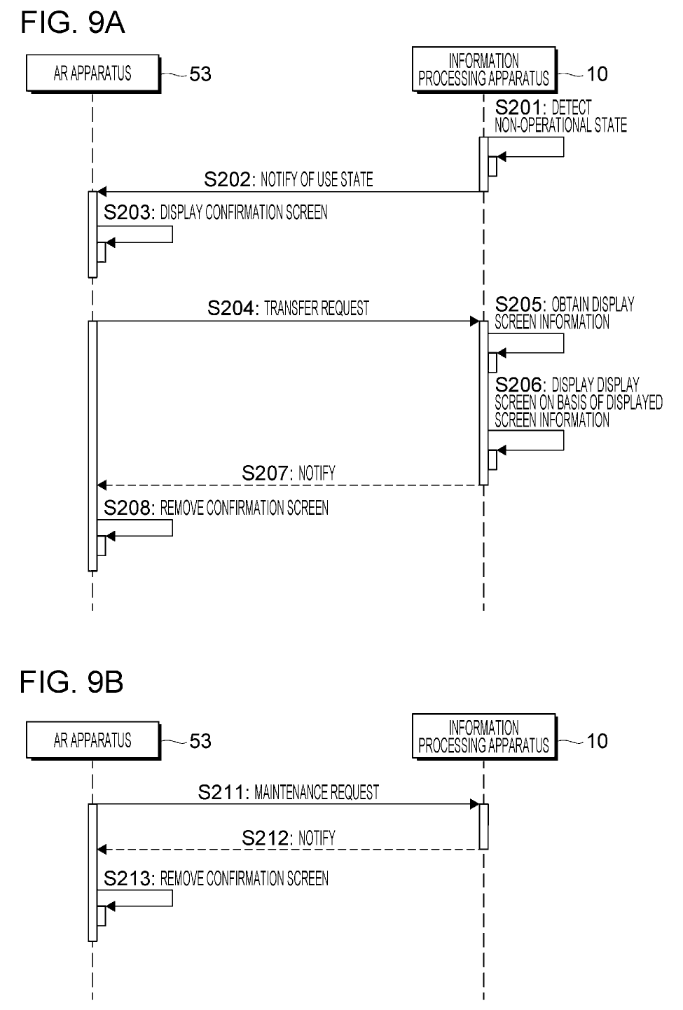

FIGS. 9A and 9B are sequence diagrams illustrating a first sequence that is an operation example of the information processing system in a case where user Z (see FIG. 5) no longer operates the information processing apparatus 10. FIG. 9A illustrates a case where user A (see FIG. 5) desires to switch to the information processing apparatus 10, and FIG. 9B illustrates a case where user A does not desire to switch to the information processing apparatus 10.

The example illustrated in FIG. 9A illustrates a case where user A (see FIG. 5) desire to switch to the information processing apparatus 10.

As illustrated in FIG. 9A, the information processing apparatus 10 detects a non-operational state in which no operation is performed by user Z (see FIG. 5) (step 201).

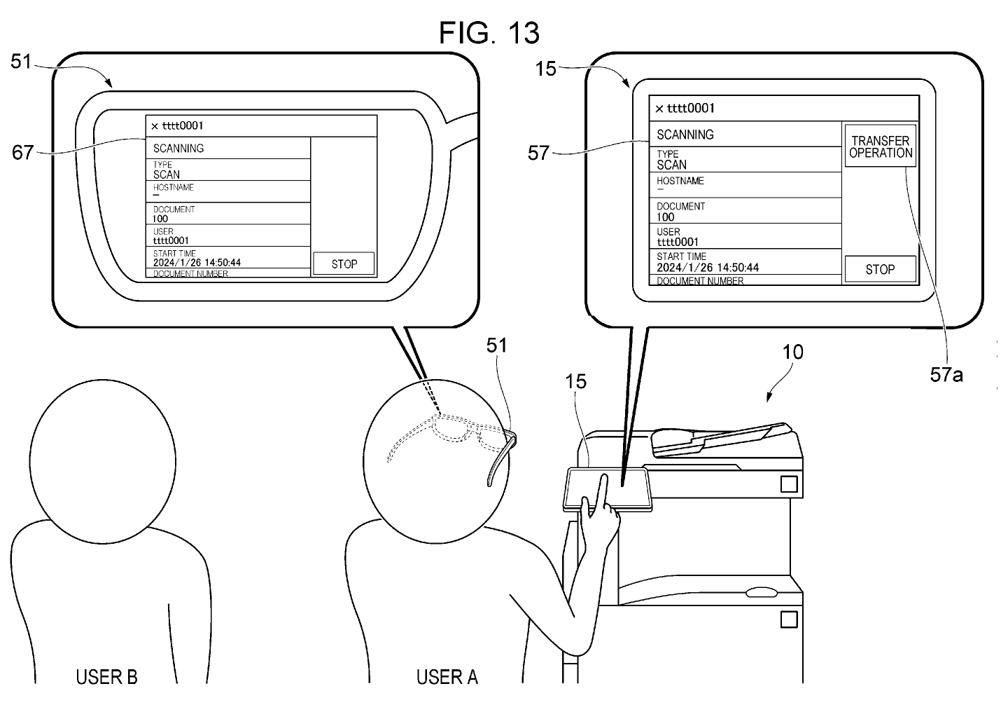

The detection of the non-operational state may be absence detection, which is detection by the human sensor 10a (see FIG. 4A). The non-operational state may also be detected by detecting that the operation panel 15 (see FIG. 5) has not been operated for a predetermined period of time, that is, by detecting that a non-operation period has elapsed. The non-operational state may also be detected when user Z (see FIG. 5) logs out or when user Z uses an end button (not illustrated) after the logout. The non-operational state may also be detected when user Z uses an operation transfer button (a button 57a in FIG. 13) described later. The detection of the non-operational state may also be any combination of the plurality of examples described above.

The detection of the non-operational state includes detection related to the operation panel 15, such as the aforementioned absence detection and the aforementioned detection of the elapse of the non-operation period, and detection related to operations performed by a user, such as logout and a user instruction.

The detection related to the operation panel 15 and the detection related to operations performed by a user are examples of predetermined conditions, and are also examples of conditions indicating that the information processing apparatus 10 is ready for use by another user.

Furthermore, the aforementioned absence detection, the detection of the lapse of the non-operation period, and the like are examples of detection of occurrence of a state in which the operation panel 15 of the information processing apparatus 10 is highly likely to be out of use. Furthermore, logout, a user instruction, and the like are examples of a case where an operation indicating that the use of the operation panel 15 of the information processing apparatus 10 is to be ended has been performed.

The use of the operation transfer button is an example of a predetermined operation.

A user other than user Z (see FIG. 5) who is operating the operation panel 15, for example, user A (see FIG. 5), is waiting for the operation of user Z to end. Therefore, control for notifying the waiting user A that the operation panel 15 is available is performed.

That is, in response to the detection of the non-operational state (step 201), the information processing apparatus 10 notifies the AR apparatus 53 used by user A (see FIG. 5) of a use state indicating the non-operational state (step 202). The notification may be performed by transmitting a signal indicating the use state.

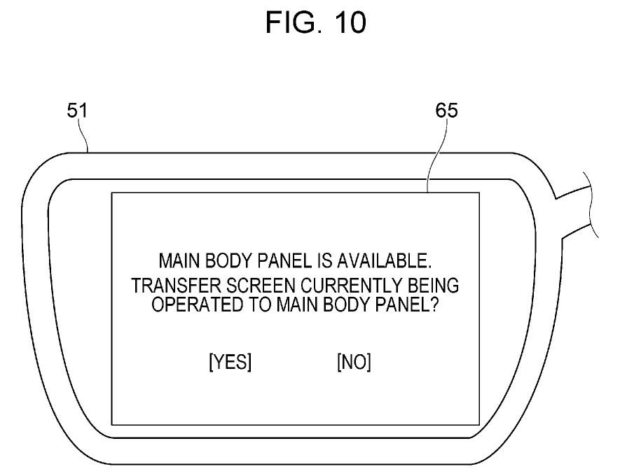

When the AR apparatus 53 receives the notification of the use state, the AR apparatus 53 displays a confirmation screen for asking user A whether to continue the operation on the operation panel 15 (step 203). That is, the confirmation screen is displayed on the AR glasses 51 (see FIG. 5) of the AR apparatus 53. As a result, user A (see FIG. 5) can select whether to use the AR apparatus 53 or the operation panel 15 to continue the operation. The confirmation screen will be described later (see FIG. 10).

For example, options "Yes" and "No" are displayed in the confirmation screen of the AR glasses 51 (see FIG. 5).

If user A (see FIG. 5) desires to continue the operation on the operation panel 15, user A selects "Yes" with the controller 52 (see FIG. 5). If user A (see FIG. 5) desires to continue the operation on the AR apparatus 53, user A selects "No" with the controller 52 (see FIG. 5).

It is assumed that, in response to the confirmation screen for confirming whether to continue the operation on the operation panel 15, user A (see FIG. 5) makes an input to the controller 52 (see FIG. 5) of the AR apparatus 53 indicating that he/she desires to transfer the operation to the operation panel 15 and continue the operation. That is, this is a case where "Yes" in the above example is selected.

Accordingly, the AR apparatus 53 makes a transfer request to the information processing apparatus 10 (step 204).

Upon receiving the transfer request, the information processing apparatus 10 performs switching processing. The switching process is processing for switching a display output for user A (see FIG. 5) and reception of operations from user A from the AR apparatus 53 to the information processing apparatus 10 and continuing the control.

That is, the information processing apparatus 10 obtains displayed screen information, which is information regarding a screen displayed on the AR glasses 51 (see FIG. 5) of the AR apparatus 53 (step 205).

The information processing apparatus 10 displays, on the operation panel 15, the display screen based on the obtained display screen information (step 206). As described above, display screen data displayed on the AR apparatus 53 is generated by the UI control unit 10a (see FIG. 4A) of the information processing apparatus 10 and is obtainable.

The information processing apparatus 10 then notifies the AR apparatus 53 that the switching processing has been completed (step 207).

The AR apparatus 53 removes the confirmation screen of the AR glasses 51 (see FIG. 5) (step 208).

User A (see FIG. 5) can thus move to the installation location of the information processing apparatus 10 and continue to perform subsequent operations using the operation panel 15 (see FIG. 5) of the information processing apparatus 10.

The example illustrated in FIG. 9B illustrates a case where user A (see FIG. 5) desires not to transfer the operation from the AR apparatus 53 to the information processing apparatus 10. That is, it is assumed that, in response to the confirmation screen (see step 203 described above) of the information processing apparatus 10, user A (see the FIG. 5) makes, to the controller 52 (see FIG. 5) of the AR apparatus 53, an input indicating that he/she desires to continue the operation on the AR apparatus 53 without switching to the information processing apparatus 10. That is, this is a case where "No" in the above example is selected.

The AR apparatus 53, therefore, issues a maintenance request to the information processing apparatus 10 (step 211).

Accordingly, the information processing apparatus 10 notifies user A (see FIG. 5) that a display output for user A and reception of operations from user A are to be continued on the AR apparatus 53 (step 212).

The AR apparatus 53 then removes the confirmation screen of the AR glasses 51 (see FIG. 5) (step 213).

As a result, user A (see FIG. 5) can continue the operation on the AR apparatus 53.

FIG. 10 is a diagram illustrating a screen example 65 as an example of the confirmation screen (see step 203 in FIG. 9A). The screen example 65 is displayed on the AR glasses 51.

As illustrated in FIG. 10, in the screen example 65, a notification, "Main body panel is available", based on the detection of the non-operational state is displayed. The notification is an example of a notification indicating that a display on a user terminal can be transferred to the operation unit. The "main body panel" refers to the operation panel 15 (see FIG. 5).

In the screen example 65, an inquiry, "Transfer screen currently being operated to main body panel?", is displayed. An inquiry part of the screen example 65 is an example of an inquiry about whether to transfer.

Two options, namely "Yes" to be selected when the user desires to continue the operation while switching to the information processing apparatus 10 and "No" to be selected when the user desires not to continue the operation, are illustrated.

### Example of Second Sequence

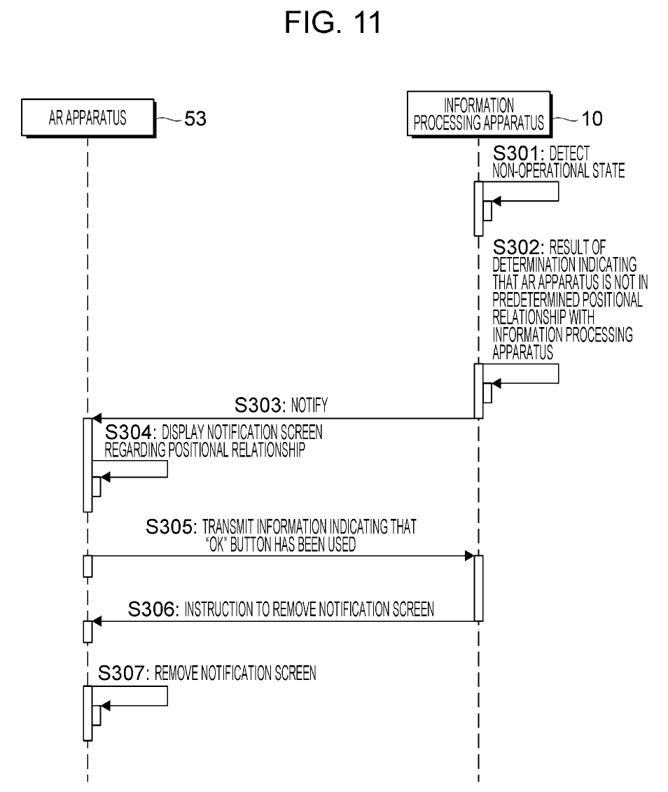

FIG. 11 is a sequence diagram illustrating a second sequence that is an operation example of the information processing system in a case where user Z (see FIG. 5) no longer operates the information processing apparatus 10. FIG. 11 corresponds to FIGS. 9A and 9B illustrating an example of the first sequence described above.

FIG. 11 is the same as FIGS. 9A and B in that while user Z (see FIG. 5) is operating the operation panel 15 of the information processing apparatus 10, user A (see FIG. 5) is performing an operation on the information processing apparatus 10 from the AR apparatus 53.

FIG. 11 is different from FIGS. 9A and B, however, in that control is performed in accordance with a positional relationship between the AR apparatus 53 used by user A and the information processing apparatus 10.

This will be described in more detail. A case where a plurality of AR apparatuses 53 is connected to the information processing apparatus 10 will be considered. The plurality of AR apparatuses 53 is located at various distances from the information processing apparatus 10. Therefore, when user Z (see FIG. 5) no longer uses the operation panel 15 of the information processing apparatus 10 and another user located far from the information processing apparatus 10 then uses the operation panel 15, it is difficult to smoothly share the operation panel 15.

In view of this, in the present exemplary embodiment, control for determining a user who will use the operation panel 15 next in consideration of a positional relationship with the information processing apparatus 10 is employed.

The second sequence will be described hereinafter.

User Z (see FIG. 5) has been using the information processing apparatus 10, but the information processing apparatus 10 detects a non-operational state indicating that the use by user Z has ended (step 301).

Next, the information processing apparatus 10 determines whether the AR apparatus 53 of user A (see FIG. 5) is in a predetermined positional relationship with the information processing apparatus 10. Here, it is assumed that a result of the determination indicates that the AR apparatus 53 is not in the predetermined positional relationship (step 302).

If the AR apparatus 53 of user A (see FIG. 5) is in the predetermined positional relationship with the information processing apparatus 10, the processing in step 202 and the subsequent steps in FIG. 9A described above is performed, and description thereof is omitted.

The information processing apparatus 10 notifies the AR apparatus 53 used by user A (see FIG. 5) of the detection of the non-operational state (step 201) and the result of the determination of the positional relationship (step 303). That is, the information processing apparatus 10 notifies the AR apparatus 53 that the information processing apparatus 10 is in the non-operational state and that the user is a little away from the information processing apparatus 10.

Upon receiving the notification from the information processing apparatus 10, the AR apparatus 53 displays a notification screen for notifying the user of the positional relationship, that is, that the user is a little away from the information processing apparatus 10 (step 304).

When user A performs an operation on, for example, an image "OK" in the notification screen, the AR apparatus 53 transmits a signal indicating the operation to the information processing apparatus 10 (step 305). Accordingly, the information processing apparatus 10 instructs the AR apparatus 53 to remove the notification screen (step 306).

The AR apparatus 53 removes the notification screen (step 307).

When the AR apparatus 53 is in the predetermined positional relationship with the information processing apparatus 10, the information processing apparatus 10 performs the processing in step 202 and the subsequent steps in FIGS. 9A and 9B described above. Therefore, description thereof is omitted.

Although the second sequence illustrated in FIG. 11 relates to a case where user A (see FIG. 5) is at the closest position to the information processing apparatus 10, the present disclosure is not limited to this case. For example, the information processing apparatus 10 identifies users who are in the predetermined positional relationship with the information processing apparatus 10, and recognizes waiting order of a plurality of users. The information processing apparatus 10 then notifies a user who will use the operation panel 15 next according to the order (step 303).

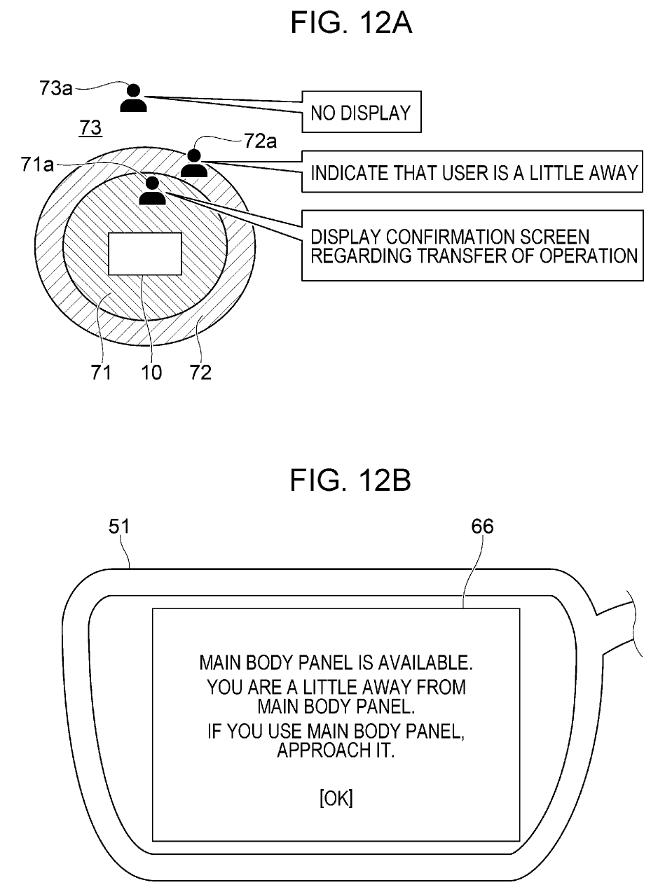

FIGS. 12A and 12B are diagrams further illustrating the second sequence: FIG. 12A is a diagram illustrating an example of the predetermined positional relationship with the information processing apparatus 10, and FIG. 12B is a diagram illustrating a screen example 66 of the AR glasses 51.

As illustrated in FIG. 12A, in the second sequence, the positional relationship with the information processing apparatus 10 is divided into three areas. That is, the positional relationship is divided into a first area 71 including the installation position of the information processing apparatus 10, a second area 72 surrounding the first area 71, and a third area 73 other than the first area 71 and the second area 72.

When it is a turn of a user 71a in the first area 71, a confirmation screen for checking whether to transfer the operation is displayed on AR glasses 51 of the user 71a. The display corresponds to the display of the notification screen regarding the positional relationship in step 304 described above. Specifically, this is the screen example 65 described above (see FIG. 10).

When it is a turn of a user 72a in the second area 72, a display indicating that the user 72a is a little away from the information processing apparatus 10 is displayed on AR glasses 51 of the user 72a. It is indicated that the user 72a needs to approach the information processing apparatus 10.

When the user 72a approaches the information processing apparatus 10 and moves into the first area 71, the above-described notification screen for the user 71a is displayed on the AR glasses 51 of the user 72a.

A screen example 66 illustrated in FIG. 12B is a display example of the notification screen. In the screen example 66, a notification, "Main body panel is available", and an advice, "You are a little away from main body panel. If you use main body panel, approach it", are included.

With regard to a user 73a in the third area 73, nothing related to the positional relationship is displayed on AR glasses 51 of the user 73a. The user 73a can issue an instruction to execute a job or the like to the information processing apparatus 10 using the AR glasses 51 thereof.

Depending on positions of the users 71a and 72a who are waiting for their turns, there may be a case where connection order is not taken into consideration (a user who is closer to the information processing apparatus 10 is prioritized) or a case where the connection order is taken into consideration (a user who has been waiting a longer time is prioritized). The connection order is order in which AR glasses 51 are connected to the information processing apparatus 10.

More specifically, there may be a control example in which the confirmation screen is displayed on the AR glasses 51 of the users 71a and 72a who are waiting for their turns in the order of connection to the information processing apparatus 10, regardless of whether the users 71a and 72a are in the first area 71 or the second area 72. Even when the user 72a has connected to the information processing apparatus 10 before the user 71a, the user 71a, who is closer to the information processing apparatus 10, may be prioritized.

It is needless to say that, in any case, when there is a plurality of users in the first area 71, the users are prioritized in the connection order. When there is a plurality of users in the second area 72, the users are prioritized in the connection order.

A modification is possible in which, when a plurality of users has connected to the information processing apparatus 10 and is waiting for their turns, the users are prioritized on the basis of attribute information regarding the users regardless of positions thereof.

### Second Exemplary Embodiment

Next, a second exemplary embodiment will be described.

A relationship between the operation panel 15 of the information processing apparatus 10 and the AR glasses 51 according to the second exemplary embodiment will be described.

FIG. 13 is a diagram illustrating the screen example 41 of the operation panel 15 of the information processing apparatus 10 and a screen example 67 of the AR glasses 51. FIG. 13 corresponds to FIG. 5 according to the first exemplary embodiment.

As illustrated in FIG. 13, the operation panel 15 of the information processing apparatus 10 is operated by user A, and the AR glasses 51 are worn by user A. User B is waiting for user A to finish operating the operation panel 15 near the information processing apparatus 10. User B is not wearing the AR glasses 51.

A screen example 57 is displayed on the operation panel 15 illustrated in FIG. 13. In the screen example 57, user A operates the operation panel 15 to cause the information processing apparatus 10 to execute a scan job.

Here, user A is about to change means of operation for the information processing apparatus 10 from the operation panel 15 to his/her own AR glasses 51. User A recognizes that user B is waiting for his/her turn, and is about to switch to his/her own AR glasses 51. That is, user A is attempting to enable user B to operate the operation panel 15 by performing subsequent operations using his/her own AR glasses 51.

For this reason, a button 57a for requesting "transfer operation" is displayed in the screen example 57. The AR glasses 51 of user A also displays the screen example 67, which has the same design as the screen example 57. The screen example 67 is an example of a job-in-progress screen.

Although the button 57a of the screen example 57 is not displayed in the screen example 67, a modification in which a button is also displayed in the screen example 67 is possible.

Use of the button 57a on the operation panel 15 is an example of an operation for instructing the operation panel 15 to transfer a display on the operation panel 15 to the AR glasses 51 communicably connected to the information processing apparatus 10.

### Example of Third Sequence

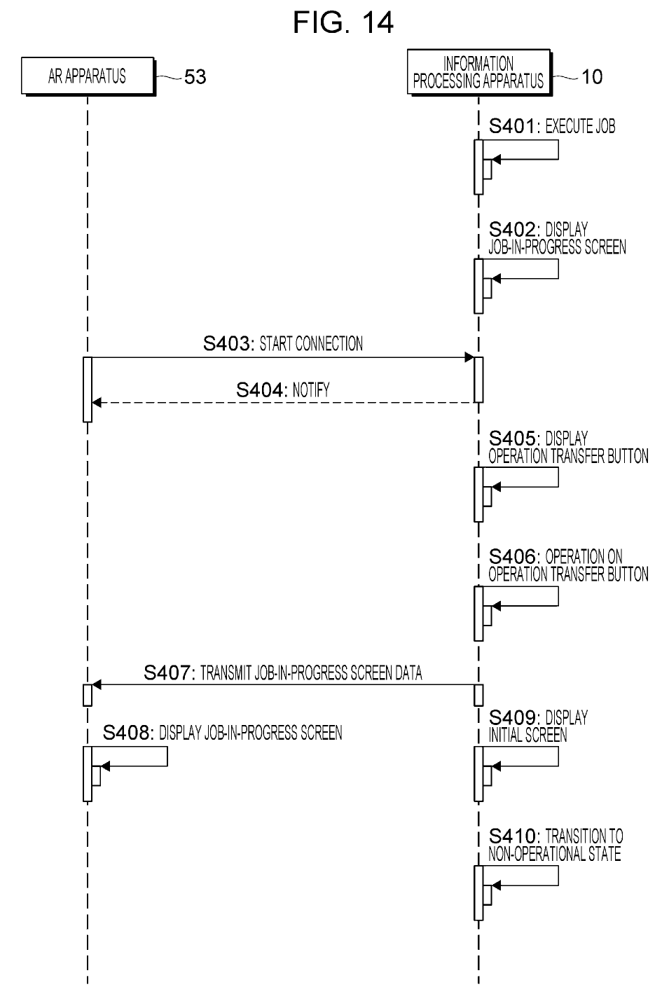

FIG. 14 is a sequence diagram illustrating a third sequence that is an operation example of the information processing system according to the second exemplary embodiment.

In the example illustrated in FIG. 14, the information processing apparatus 10 is executing a job in response to an operation performed on the operation panel 15 (see FIG. 13) (step 401). The operation panel 15, therefore, displays a job-in-progress screen (step 402).

The job being executed is a job executed when user A (see FIG. 13) operates the operation panel 15 (see FIG. 13).

User A operates his/her own AR apparatus 53 to start connection to the information processing apparatus 10 (step 403). In response to this, the information processing apparatus 10 issues a connection confirmation notification (step 404).

When the information processing apparatus 10 recognizes that user A is operating the operation panel 15 and has started to connect to the AR apparatus 53, the information processing apparatus 10 displays an operation transfer button on the operation panel 15 (step 405).

More specifically, while user A is operating the operation panel 15 of the information processing apparatus 10, user A starts to connect his/her own AR apparatus 53 to the information processing apparatus 10. This is because user A has ended an operation using the information processing apparatus 10 and desires to perform subsequent operations using the AR apparatus 53.

The information processing apparatus 10, therefore, displays the operation transfer button to check whether user A desires to transfer the operation performed on the operation panel 15 to his/her own AR apparatus 53.

The operation transfer button may be displayed on the AR glasses 51 (see FIG. 5) of the AR apparatus 53 instead of, or in addition to, the operation panel 15.

When the operation transfer button is used on the operation panel 15 (step 406), the information processing apparatus 10 transmits data on the job-in-progress screen displayed on the operation panel 15 to the AR apparatus 53 (step 407).

As a result, the job-in-progress screen is displayed on the AR glasses 51 (see FIG. 5) of the AR apparatus 53 (step 408).

Next, the information processing apparatus 10 displays an initial screen on the operation panel 15 (step 409), and transitions to a non-operational state, in which no operation is being performed by the user (step 410).

When the information processing apparatus 10 receives an instruction from the AR apparatus 53, the information processing apparatus 10 performs processing corresponding to the instruction.

Although an example of the predetermined positional relationship with the information processing apparatus 10 has been described with reference to FIG. 12A, other examples are possible.

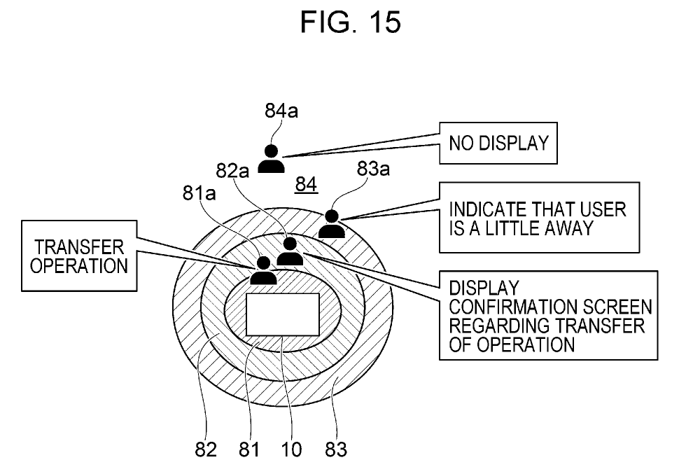

FIG. 15 is a diagram illustrating another example of the predetermined positional relationship with the information processing apparatus 10, which is different from the example illustrated in FIG. 12A referred to above.

As illustrated in FIG. 15, in this example of the positional relationship, the positional relationship with the information processing apparatus 10 is divided into four areas. That is, the positional relationship is divided into a first area 81 including the installation position of the information processing apparatus 10, a second area 82 surrounding the first area 81, a third area 83 surrounding the second area 82, and a fourth area 84 other than the first area 81, the second area 82, and the third area 83.

The information processing apparatus 10 thus monitors a distance to the AR apparatus 53 (see, for example, FIG. 8) in four stages.

With regard to a user 81a in the first area 81, the operation is transferred. When it is a turn of a user 82a in the second area 82, a confirmation screen for checking whether to transfer the operation is displayed on AR glasses 51 of the user 82a.

When it is a turn of a user 83a in the third area 83, a display indicating that the user 83a is a little away from the information processing apparatus 10 is displayed on AR glasses 51 of the user 83a. With regard to a user 84a in the fourth area 84, nothing related to the positional relationship is displayed on AR glasses 51 of the user 84a.

A specific example will be described.

As a specific example, the button 57a (see FIG. 13) for requesting "transfer operation" is displayed on the operation panel 15 operated by user A (see FIG. 13).

When the button 57a is used, the screen is switched to a list of terminals that communicate with the information processing apparatus 10. When user A selects his/her own AR glasses 51 in the displayed list, the above-described display according to a position relative to the information processing apparatus 10 is performed. The list may be displayed in order of signal strength or in order of service set identifier (SSID) name. The order of signal strength roughly corresponds to the positional relationship with the information processing apparatus 10.

Another specific example will be described. A button (see the button 57a in FIG. 13) for requesting "transfer operation" is displayed on the AR glasses 51 operated by user A (see FIG. 5).

When the button is used, the screen switches to a list of terminals that communicate with the information processing apparatus 10. When user A selects his/her own AR glasses 51 in the displayed list, the above-described display according to the position relative to the information processing apparatus 10 is performed.

Although exemplary embodiments of the present invention have been described, these exemplary embodiments do not limit the scope of the present invention. It will be apparent from the claims that various modifications and variations can be made to the above exemplary embodiments without departing from the scope of the present invention.

The present invention is also applicable to a program and a program product.

### Appendix

(((1)))

An information processing apparatus comprising: an operation unit configured to be operated by a user in response to a display and a processor configured to receive the operation performed on the operation unit and control the display output to the operation unit in response to the received operation, wherein the processor is configured to output, when a user terminal is communicably connected to the information processing apparatus, the display to the user terminal and receive the operation on the user terminal, and transfer, when a predetermined condition is satisfied, a display output to one of the operation unit and the user terminal and the reception of the operation on the one of the operation unit and the user terminal to the other and continue control.

(((2)))

The information processing apparatus according to (((1))), wherein the predetermined condition is a condition indicating that, when the operation unit is in use and is unavailable for use by a user other than the user who is using the operation unit, the operation unit has become available for use by the other user, wherein the one of the operation unit and the user terminal is the user terminal, and wherein the other is the operation unit of the information processing apparatus.

(((3)))

The information processing apparatus according to (((2))), wherein the condition indicating that the operation unit has become available is detection of occurrence of a state in which the operation unit is likely to be out of use.

(((4)))

The information processing apparatus according to (((2))), wherein the condition indicating that the operation unit has become available is that an operation indicating an end of use of the operation unit is performed.

(((5)))

The information processing apparatus according to (((1))), wherein the one of the operation unit and the user terminal is the user terminal, and wherein, when the other is the operation unit of the information processing apparatus, the user terminal is in a predetermined positional relationship with the information processing apparatus.

(((6)))

The information processing apparatus according to (((5))), wherein, when a plurality of user terminals is in the predetermined positional relationship, the user terminal, which is the one of the operation unit and the user terminal, is a user terminal that is closest to the information processing apparatus among the plurality of user terminals.

(((7)))

The information processing apparatus according to (((5))), wherein, when a plurality of user terminals is in the predetermined positional relationship, the user terminal, which is the one of the operation unit and the user terminal, is a user terminal having the longest elapsed time from connection to the information processing apparatus.

(((8)))

The information processing apparatus according to any one of (((5))) to (((7))), wherein the user terminal, which is the one of the operation unit and the user terminal, issues a notification indicating that the display on the user terminal can be transferred to the operation unit and an inquiry as to whether to transfer the display on the user terminal.

(((9)))

The information processing apparatus according to any one of (((5))) to (((7))), wherein information is displayed on a user terminal located farther from the information processing apparatus than the predetermined positional relationship, the information indicating that the user terminal needs to be closer to the information processing apparatus in order to transfer a display.

(((10)))

The information processing apparatus according to (((1))), wherein the predetermined condition is that a predetermined operation is performed, wherein the one of the operation unit and the user terminal is the operation unit of the information processing apparatus, and wherein the other is the user terminal.

(((11)))

The information processing apparatus according to (((10))), wherein the predetermined operation is an operation for instructing the operation unit to transfer the display on the operation unit to the user terminal communicably connected to the information processing apparatus.

(((12)))

The information processing apparatus according to any one of (((1))) to (((11))), wherein the display output to the operation unit and the display output to the user terminal communicably connected to the information processing apparatus have a common display mode.

(((13)))

The information processing apparatus according to (((12))), wherein, with respect to an item that is being executed by operating one of the user terminal and the operation unit among items executable by the information processing apparatus, the display on the other indicates that the item is disabled.

(((14)))

A program causing an information processing apparatus including an operation unit configured to be operated by a user in response to a display and a processor configured to receive the operation performed on the operation unit and control the display output to the operation unit in response to the received operation to execute a process comprising: outputting, when a user terminal is communicably connected to the information processing apparatus, the display to the user terminal and receiving the operation on the user terminal; and transferring, when a predetermined condition is satisfied, a display output to one of the operation unit and the user terminal and the reception of the operation on the one of the operation unit and the user terminal to the other and continuing control.

What is claimed is:

1. An information processing apparatus comprising:
an operation unit configured to be operated by a user in response to a display; and
a processor configured to receive the operation performed on the operation unit and control the display output to the operation unit in response to the received operation,
wherein the processor is configured to:
output, when a user terminal is communicably connected to the information processing apparatus, the display to the user terminal and receive the operation on the user terminal, and
transfer, when a predetermined condition is satisfied, a display output to one of the operation unit and the user terminal and the reception of the operation on the one of the operation unit and the user terminal to the other and continue control.

2. The information processing apparatus according to claim 1,
wherein the predetermined condition is a condition indicating that, when the operation unit is in use and is unavailable for use by a user other than the user who is using the operation unit, the operation unit has become available for use by the other user,
wherein the one of the operation unit and the user terminal is the user terminal, and
wherein the other is the operation unit of the information processing apparatus.

3. The information processing apparatus according to claim 2,
wherein the condition indicating that the operation unit has become available is detection of occurrence of a state in which the operation unit is likely to be out of use.

4. The information processing apparatus according to claim 2,
wherein the condition indicating that the operation unit has become available is that an operation indicating an end of use of the operation unit is performed.

5. The information processing apparatus according to claim 1,
wherein the one of the operation unit and the user terminal is the user terminal, and
wherein, when the other is the operation unit of the information processing apparatus,
the user terminal is in a predetermined positional relationship with the information processing apparatus.

6. The information processing apparatus according to claim 5,
wherein, when a plurality of user terminals is in the predetermined positional relationship,
the user terminal, which is the one of the operation unit and the user terminal, is a user terminal that is closest to the information processing apparatus among the plurality of user terminals.

7. The information processing apparatus according to claim 5,
wherein, when a plurality of user terminals is in the predetermined positional relationship,
the user terminal, which is the one of the operation unit and the user terminal, is a user terminal having the longest elapsed time from connection to the information processing apparatus.

8. The information processing apparatus according to claim 5,
wherein the user terminal, which is the one of the operation unit and the user terminal, issues a notification indicating that the display on the user terminal can be transferred to the operation unit and an inquiry as to whether to transfer the display on the user terminal.

9. The information processing apparatus according to claim 5,
wherein information is displayed on a user terminal located farther from the information processing apparatus than the predetermined positional relationship, the information indicating that the user terminal needs to be closer to the information processing apparatus in order to transfer a display.

10. The information processing apparatus according to claim 1,
wherein the predetermined condition is that a predetermined operation is performed,
wherein the one of the operation unit and the user terminal is the operation unit of the information processing apparatus, and
wherein the other is the user terminal.

11. The information processing apparatus according to claim 10,
wherein the predetermined operation is an operation for instructing the operation unit to transfer the display on the operation unit to the user terminal communicably connected to the information processing apparatus.

12. The information processing apparatus according to claim 1,
wherein the display output to the operation unit and the display output to the user terminal communicably connected to the information processing apparatus have a common display mode.

13. The information processing apparatus according to claim 12,
wherein, with respect to an item that is being executed by operating one of the user terminal and the operation unit among items executable by the information processing apparatus, the display on the other indicates that the item is disabled.

14. A non-transitory computer readable medium storing a program causing an information processing apparatus including an operation unit configured to be operated by a user in response to a display and a processor configured to receive the operation performed on the operation unit and control the display output to the operation unit in response to the received operation to execute a process comprising:
outputting, when a user terminal is communicably connected to the information processing apparatus, the display to the user terminal and receiving the operation on the user terminal; and
transferring, when a predetermined condition is satisfied, a display output to one of the operation unit and the user terminal and the reception of the operation on the one of the operation unit and the user terminal to the other and continuing control.
